(19) United States
(12) Patent Application Publication
(10) Pub. No.: US 2005/0249908 A1
(43) Pub. Date: Nov. 10, 2005

(54) Vapor retarding film and folding thereof

(76) Inventors: Richard S. Duncan, Royersford, PA (US); Glenn J. Singer, West Chester, PA (US); Bruce A. Hartzell, Mickleton, NJ (US); Eric J. Brown, Collegeville, PA (US); John Edwin Jeffers, King of Prussia, PA (US)

Correspondence Address: DUANE MORRIS, LLP;IP DEPARTMENT, 30 SOUTH 17TH STREET, PHILADELPHIA, PA, 19103-4196, US

(21) Appl. No.: 11/123,665

(22) Filed: May 6, 2005

Related U.S. Application Data
(60) Provisional application No. 60/569,743, filed on May 10, 2004.

(51) Int. Cl. B32B 9/00

(52) U.S. Cl. 428/40.1; 428/124

(57) ABSTRACT

A vapor retarding film (100) adapted for installation, the film (100) having one or more folds (102a), (102b) and (102c) defining a folded film section (102); an edge margin (104) of the film (100) adapted for fastening to a building wall without requiring complete unfolding of the folded film section (102), by having the edge margin (104) being unfolded in the folded film section (102), and wherein the film (100) is made by folding a length of the film (100) lengthwise of the edge margin (104) and rolling the film lengthwise to form a roll (110).

### BACKGROUND OF THE INVENTION

Field of the Invention

The present invention relates to a vapor retarding film adapted for installation against a building frame to provide a vapor barrier for a building.

A flexible plastic film, such as, polyethylene, is installed against an interior side of a building frame, prior to installing interior wallboard to cover the building frame. The building frame defines a hollow wall cavity that is filled or at least covered with fibrous insulation material to retard heat transfer through the wall. The vapor retarding film provides a vapor barrier between warm humidity of the air in the interior of a building and the fibrous insulation material.

Typically, the vapor retarding film is manufactured in a continuous length. The width of the vapor retarding film corresponds to the height of an interior wall of a building. For example, the width corresponds to a wall height of 8 feet, 10 feet or 12 feet, with an added width of 3-4 inches to account for a stapling margin and to account for some allowable deviations in a plumb surface of the lumber of a building frame against which the film is installed. The film is sold in rolls of cut lengths of up to 100 feet. The film is always folded before rolling to provide a folded film in a roll of 2-3 feet wide. One disadvantage of the folded film is that the film layers are difficult to separate and hold apart from one another, especially in dry conditions wherein the presence of static electricity keeps the folded layers attracted to one another. Despite the presence of static electricity, an installer of the film is required to unfold an edge of the film and hold the edge in place against the building frame while holding the remainder of the film and stapling the edge to the frame. In the past, the film was folded with a geometry for ease in manufacturing, and was not folded for ease in installation.

### BRIEF SUMMARY OF THE INVENTION

The present invention relates to a vapor retarding film that is adapted for installation when in a folded film configuration.

Further, the present invention relates to a method of manufacturing a vapor retarding film in a folded section that is adapted for installation of the film without requiring complete unfolding of the folded section.

According to an embodiment of the invention, a vapor retarding film has a folded film section, and an edge margin of the film that is adapted for fastening to a top plate of a building frame without requiring complete unfolding of the folded film section, by having the edge margin being unfolded along its length.

According to another embodiment of the invention, the edge margin extends along a wall facing, exposed section of the film.

According to another embodiment of the invention the folded section has one or more folds extending substantially lengthwise of the edge margin.

According to another embodiment of the invention the folded film is rolled up to form a roll lengthwise of the edge margin.

Other embodiments of the invention are apparent from the following detailed description taken in conjunction with the accompanying drawings.

### BRIEF DESCRIPTION OF THE DRAWINGS

FIG. 1A is an edge view of a vapor retarding film while in a folded configuration that is adapted for installation.

FIG. 1B is an edge view of another embodiment of a vapor retarding film adapted for installation.

FIG. 1C is an edge view of another embodiment of a vapor retarding film adapted for installation.

FIG. 1D is an isometric view of a roll of the vapor retarding film disclosed by FIG. 1A.

FIG. 1E is an isometric view of a roll of the vapor retarding film disclosed by FIG. 1B.

FIG. 1F is an isometric view of a roll of the vapor retarding film disclosed by FIG. 1C.

FIG. 2 is a diagrammatic view of installation of a vapor retarding film to a building wall of frame construction after installation of fibrous insulation material.

FIG. 3 is a flow chart of various embodiments of a method of making a vapor retarding film adapted for installation according to the invention.

### DETAILED DESCRIPTION OF THE INVENTION

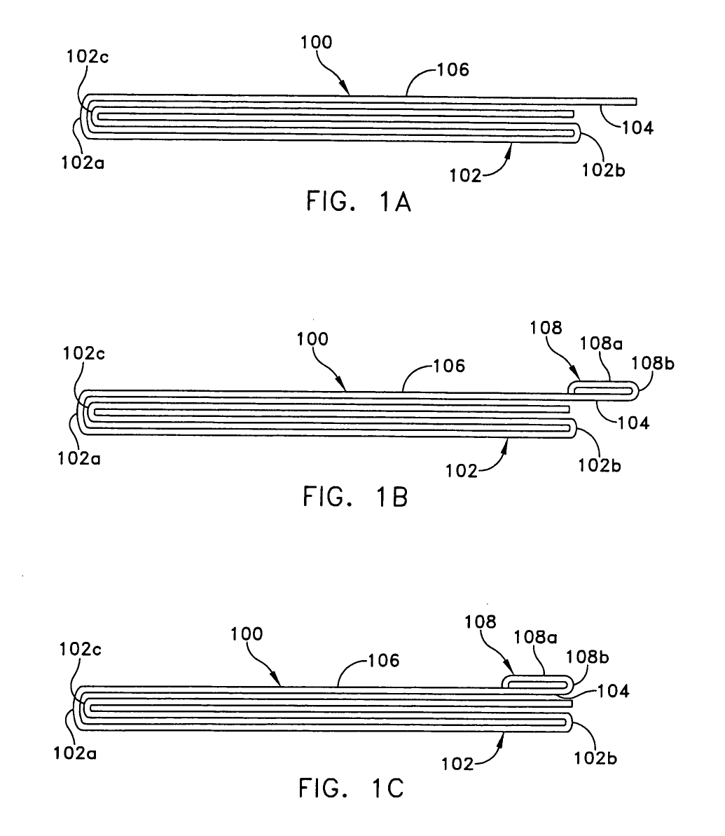

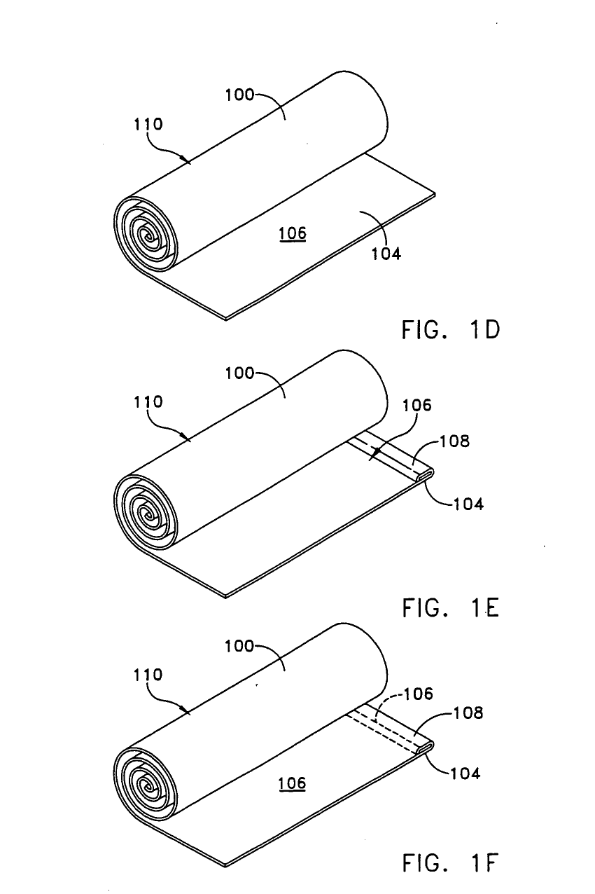

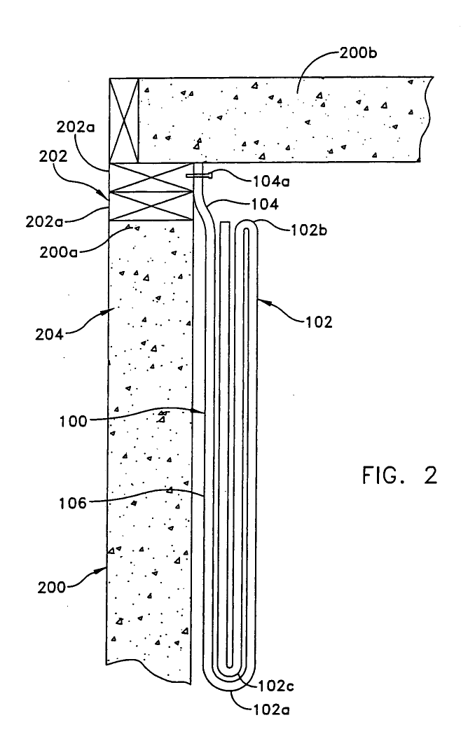

With reference to FIG. 1A, a vapor retarding film (100), including and not limited to a film of; Polyamide (PA), Polyethylene (PE), Polypropylene (PP), Polybutylene (PB), Polyvinylchloride (PVC), Polyvinylacetate (PVA), Polyethylene terathalate (PET), Polyvinylidene chloride (PVDC), polyester, polystyrene, polypropylene, fluoropolymer, polyvinyl, polyurethane and polycarbonate. A vapor retarding film (100) is a film that either forms a barrier to transmission of water vapor, or selectively transmits water vapor depending on the relative humidity of ambient air. For example, a nonwoven, high density polyethylene is a barrier to absorption and transmission of water vapor therethrough, compared to a 1 mil thickness, polyamide film that can absorb water vapor of ambient air below a preselected level of relative humidity, thereby to transmit the same therethrough. According to the present invention, the vapor retarding film (100) is adapted for installation to cover an exterior wall of a building or to cover an interior wall of a building. Further, the vapor retarding film (100) is adapted for either permanent installation to permanently cover a building wall, or temporary installation to be removed from the building wall when it is not intended to permanently cover the building wall.

The film thickness is in the range of 1 mil up to a film thickness mil that is readily folded and rolled into a compact unit for shipping and handling. The film (100) has a length of up to 100 feet. The film (100) is folded with one or more folds. For example, the film (100) is shown with three lengthwise folds (102a), (102b) and (102c) defining a folded film section (102). The film (100) when unfolded has a width that corresponds to a wall height of 8 feet, 9 feet, 10 feet or 12 feet. Further, the film (100) has an extra width of 3-4 inches to account for a stapling margin and to account for allowable deviations in a plumb surface of lumber in a building frame to which the film (100) is to be attached.

According to an embodiment of the invention, FIG. 1A discloses that the extra width of 3-4 inches forms an edge margin (104) adapted for fastening to a wall of a building to provide a vapor retarding film (100) covering the wall of a building.

FIG. 2 discloses a wall of a building that is in the form of a lumber building frame. The film (100) will now be described, by way of example, relative to installation on a building wall, the wall being, by way of example, a building wall in the form of the lumber building frame. The film (100) is adapted for installation by fastening the same to a building wall without requiring complete unfolding of the folded film section (102). Further, the film (100) will now be described, by way of example, as being installed on an interior of a building wall. The film (100) can be installed on an exterior of a building wall similarly as now described.

With reference to FIG. 2, the film (100) is adapted to be fastened to the building wall, for example, in the form of a lumber frame, without requiring complete unfolding of the folded film section (102), by having the edge margin (104) being unfolded and exposed lengthwise of the film (100). When the film (100) is unrolled lengthwise, the edge margin (104) is unrolled lengthwise. Further, when the film (100) is unrolled, the edge margin (104) is exposed. Further exposed is a wall facing, exposed section (106) of the film (100) that extends from the exposed edge margin (104) to the first fold (102a). The edge margin (104) extends lengthwise along the wall facing exposed section (106).

As disclosed by FIG. 2, the wall facing exposed section (106) faces the building wall (200) in the form of a lumber frame of known construction. The building wall (200) has spaced apart vertical studs (200a) that are end nailed to a top plate (202). Overhead, joists or attic purlins (200b) are supported by the top plate (202). Insulation material (204) fills each cavity between studs (200a). For purposes of illustration, a stud (200a) is shown, whereas the stud (200a) is actually covered by the insulation material (204). Each of the one or more folds (102a), (102b) and (102c) extends substantially lengthwise of the edge margin (104). The exposed edge margin (104) is offset from the folded film section (102), and the exposed, offset edge margin 104) projects beyond the folded film section (102). The edge margin (104) is about as wide as a top plate (202) of the building frame construction. For example, the edge margin (104) is about as wide as a double top plate (202) constructed with a stack of two thicknesses of 2×4 or 2×6 boards (202a). Alternatively, a single top plate (202) is constructed with a single one of the 2×4 or 2×6 boards (202a). Thus, the edge margin (104) according to the invention is selected to be about as wide as either a double top plate (202) or a single top plate (202). Because the edge margin (104) projects beyond the remainder of the film (100), and more particularly, beyond the folded film section (102), an installer is enabled to hold the folded film section (102) in his or her arms while holding the projecting edge margin (104) against the top plate (202) with one hand. With the other hand, the installer fastens the edge margin (104) to the top plate (202), for example, by applying staples (104) with a staple gun. Accordingly, the projecting edge margin (104) is adapted for fastening to the top plate (202) without requiring complete unfolding of the folded film section (102). Any static electricity present in the folded section (102) prior to the invention was a deterrent to separating an edge of the film (100) and fastening the film (100) to the building wall (200). According to the invention, the static electricity assists in keeping the folded film section (102) together, making it easy to hold by an installer. At the same time, the edge margin (104) readily projects from the folded film section (102) for fastening to the building wall (200). After the entire top plate (102) is covered by the film (100) to the extent as desired, the folded film section (102) is completely unfolded. Further stapling of the film (100) is performed to attach the film (100) along the lengths of the studs (200a).

FIG. 1B discloses another embodiment of the invention, wherein the exposed, offset, projecting edge margin (104) is similar to that disclosed by FIG. 1. Further, a strip of an adhesive assembly (108) is permanently attached to the edge margin (104). The adhesive assembly (108) includes a pressure sensitive adhesive (108a) temporarily covered by a removable, non-adhesive protecting film (108b). For example, an embodiment of the adhesive assembly (108) includes a double sided adhesive tape (108a) permanently adhered to the edge margin (104) and covered by a peel off film (108b), which is commercially available from the 3M Company, Minneapolis, Minn. The adhesive assembly (108) stiffens the edge margin (104), which makes the edge margin (104) easier to manipulate during installation. The present invention enables an installer to peel away the protecting film (108b) progressively, while pressing the adhesive (108a) against the top plate (202), thereby fastening the edge margin (104) to the top plate (104).

FIG. 1C discloses another embodiment of the invention, wherein the exposed edge margin (104) is covered by the pressure sensitive adhesive assembly (108). The adhesive assembly (108) stiffens the exposed edge margin (104), which makes the edge margin (104) easier to separate from the remainder of the film (100). Thereby, the film (100) is folded such that the edge margin (104) does not project beyond the folded film section (102), and, instead, is within the perimeter of the folded film section (102). The adhesive assembly (108) stiffens the edge margin (104), which makes the edge margin (104) easier to manipulate during installation. Thereby, the edge margin (104) is easily manipulated while being fastened to the top plate (104) without requiring complete unfolding of the folded film section (102).

FIG. 1D discloses the film (100) comprising the embodiment of FIG. 1A, being rolled up on itself to form a compact roll (110) lengthwise of the edge margin (104) that forms a rolled edge of the roll (110). FIG. 1E discloses the film (100) comprising the embodiment of FIG. 1B being rolled up on itself to form a compact roll (110) lengthwise of the edge margin (104) that forms a rolled edge of the roll (110). FIG. 1F discloses the film (100) comprising the embodiment of FIG. 1C, being rolled up on itself to form a compact roll (110) lengthwise of the edge margin (104) that forms a rolled edge of the roll (110). For illustration purposes in each of FIGS. 1D, 1E and 1F, the roll (110) is shown partially unrolled. However, for shipment and handling the roll (110) is completely rolled.

The roll (110) is adapted to enable an installer to fasten the film (100) to the building wall, for example, the top plate (202) without requiring unrolling of the roll (100). In each of FIGS. 1D, 1E and 1F, the roll (110) is rolled in a clockwise direction with the wall facing section (106) on the inside of the roll (110) facing the core of the roll (110). Thus, the installer holds the roll (110) in the left hand, with the edge margin (104) facing upward from a remainder of the roll (110). The installer unrolls a short length of the film (100), and positions a short length of the edge margin (104) into position against the building wall. With the right hand, the installer staples the edge margin (104) to the top plate (220). The installer repeats the process described herein until the wall is covered to an extent as desired. Thereafter, any remaining part of the roll (110) is cut off, for example, using a razor knife. The film (100) that has been fastened to the building wall is then completely unfolded. Further stapling of the film (100) is performed to attach the film (100) along the lengths of the studs (200a).

Although, the film (100) is adapted for installation while the film (100) is in the roll (110), the film (100) is further adapted for installation after unrolling the film (100) from the roll (110). The unrolled film (100) can be cut to length before installation against a corresponding length of building wall. The unrolled film (100) is not required to be unfolded prior to installation.

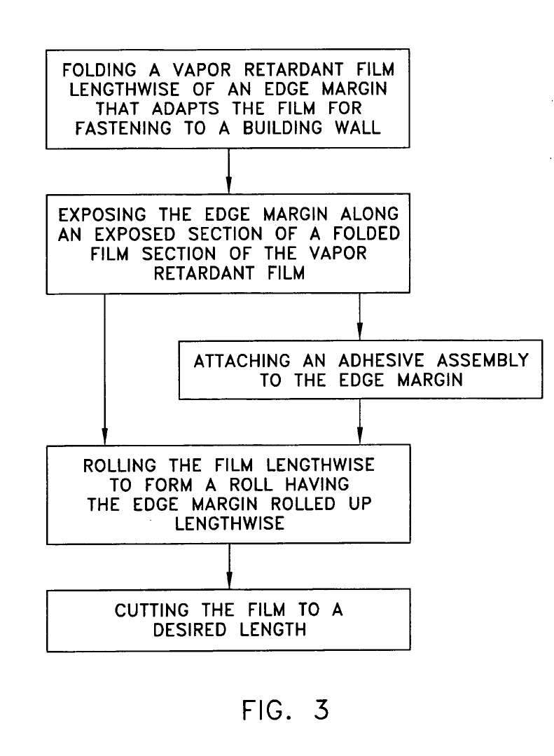

FIG. 3 discloses a method performed by known manufacturing apparatus for making a vapor retarding film according to the embodiments of the invention. The method is based on a need to select an edge margin (104) of a continuous film (100) for fastening to a top plate (202). The method includes the step of folding the vapor retarding film (100) lengthwise of the edge margin (104) that adapts the film (100) for fastening to a building frame. Further, the method includes the step of exposing the edge margin along an exposed section (106) of a folded film section (102) that has been provided by the step of folding the vapor retarding film (100). Further the method includes the step of rolling the film (100) lengthwise to form a roll having the edge margin (104) rolled up lengthwise, which forms the embodiment disclosed by FIG. 1D. Alternatively, the method includes the step of attaching an adhesive assembly ((108) to the exposed edge margin (104), followed by the step of rolling the film (100) lengthwise to form a roll, and resulting in the embodiment disclosed by FIG. 1E or FIG. 1F.

The step of folding the film (100) further includes, folding the film (100) with one or more folds (102a), (102b) and (102c). A folded film section (102) results. The folded film section (102) has the edge margin (104) extending along an exposed section (106) of the folded film section (102), such that the edge margin (104) is adapted for fastening to a top plate (202) of a building frame construction without requiring complete unfolding of the folded film section (102).

The method includes the step of cutting the film (100) to a desired length. Although FIG. 3 discloses the step as being performed after the step of rolling the film lengthwise, the invention includes performance of the step of cutting the film (100) to a desired length prior to any of the method steps disclosed by FIG. 3.

Although some preferred embodiments of the invention are described herein, other embodiments and modifications thereof are intended to be covered by the spirit and scope of the appended claims.

1. A vapor retarding film adapted for installation, the film comprising:
the film having one or more folds defining a folded film section;
an edge margin of the film adapted for fastening to a building wall without requiring complete unfolding of the folded film section, by having the edge margin being unfolded in the folded film section.

2. The vapor retarding film as in claim 1, further comprising:
the edge margin being exposed along a wall facing, exposed section of the film.

3. The vapor retarding film as in claim 1, further comprising:
each of the one or more folds extending substantially lengthwise of the edge margin.

4. The vapor retarding film as in claim 1, further comprising:
the edge margin being about as wide as a single top plate of a building frame construction.

5. The vapor retarding film as in claim 1, further comprising:
the edge margin being about as wide as a double top plate of a building frame construction.

6. The vapor retarding film as in claim 1, further comprising:
the folded film being rolled up on itself to form a compact roll lengthwise of the edge margin.

7. The vapor retarding film as in claim 1, further comprising:
a wall facing portion of the film extending from the edge margin to a first fold; and
the film unfolding by pivoting outward from the building wall along the first fold.

8. The vapor retarding film as in claim 1, further comprising:
the edge margin being an offset portion of the folded film section; and
the offset portion projecting beyond a remainder of the folded film section.

9. The vapor retarding film as in claim 1, further comprising:
the edge margin being covered by an adhesive; and
the adhesive being covered by a peel away non-adhesive film.

10. A method of manufacturing a folded vapor retarding film comprising the steps of:
selecting a portion of the film to have an edge margin for fastening to a building wall; and
folding a remainder of the film with one or more folds to provide a folded film section with the edge margin extending along an exposed section of the folded film section, such that the edge margin is adapted for fastening to the building wall without requiring complete unfolding of the folded film section.

11. The method of claim 10, further comprising the step of:
projecting the edge margin beyond the remainder of the folded film.

12. The method of claim 10, further comprising the step of:
folding the remainder of the film to project the edge margin beyond the remainder of the film.

13. The method of claim 10, further comprising the step of:
rolling the folded film section to form a compact roll.

14. A method of manufacturing a folded vapor retarding film comprising the steps of:
folding the film lengthwise of an edge margin of the film;
exposing the edge margin along an exposed section of a folded film section; and
rolling the film lengthwise of the edge margin.

15. The method according to claim 15, further comprising the step of;
attaching an adhesive assembly on the edge margin prior to folding the film.

16. The method according to claim 15, further comprising the step of;
cutting the film to a desired length.
